(19) United States
(12) Patent Application Publication
(10) Pub. No.: US 2026/0259789 A1
(43) Pub. Date: Sep. 3, 2026

(54) MULTISTAGE RECOVERY OF PROCESSOR VOLTAGE RAIL AGING FAILURES

(71) Applicant: QUALCOMM Incorporated, San Diego, CA (US)

(72) Inventors: Dinesh Kumar CHOUDHARY, Tonk (IN); Sai Sneha Venkata YESANTARAO, Hyderabad (IN); Sai Sumanth MANCHUKONDA, Rangareddy (IN)

(21) Appl. No.: 19/067,177

(22) Filed: Feb. 28, 2025

(51) Int. Cl. G06F 11/07; G06F 1/26

(52) U.S. Cl. CPC G06F 11/079; G06F 1/26; G06F 11/0721

(57) ABSTRACT

Aspects of the disclosure are directed to multistage recovery (MSR) of processor voltage rail aging failures. In accordance with one aspect, the disclosure includes setting a first process corner voltage for the first processor; confirming voltage stability of the first process corner voltage; performing an integrity check with the first process corner voltage; acquiring a plurality of aging measurements on the plurality of processors by comparing an aging measurement on a first ring oscillator (RO) and on a second ring oscillator (RO) to a measurement threshold; computing an average aging measurement from the plurality of aging measurements; and updating a plurality of aging parameters using the average aging measurement.

### TECHNICAL FIELD

This disclosure relates generally to the field of processor dc power management, and, in particular, to a multistage recovery (MSR) of processor voltage rail aging failures.

### BACKGROUND

A plurality of processors is energized by a dc power management system. The dc power management system includes a plurality of voltage rails which deliver voltage references to the plurality of processors. The voltage references delivered by the plurality of voltage rails may need adjustment over time due to load aging phenomena. Therefore, some recovery technique may be established to optimize voltage rail aging adjustment.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides multistage recovery (MSR) of processor voltage rail aging failures. Accordingly, the present disclosure discloses an apparatus including: a non-transitory memory configured to store a plurality of aging parameters; a controller coupled to the non-transitory memory, the controller configured to perform a plurality of aging measurements on a plurality of processors using the plurality of aging parameters; and a databus coupling the non-transitory memory to the controller.

Another aspect of the disclosure provides a method including: setting a first process corner voltage for the first processor; confirming voltage stability of the first process corner voltage; performing an integrity check with the first process corner voltage; acquiring a plurality of aging measurements on the plurality of processors by comparing an aging measurement on a first ring oscillator (RO) and on a second ring oscillator (RO) to a measurement threshold; computing an average aging measurement from the plurality of aging measurements; and updating a plurality of aging parameters using the average aging measurement.

Another aspect of the disclosure provides a non-transitory computer-readable medium storing computer executable code, operable on a device including at least one processor and at least one memory coupled to the at least one processor, wherein the at least one processor is configured to implement determination of aging parameters for a plurality of voltage rails, the computer executable code including: instructions for causing a computer to set a first process corner voltage for the first processor; instructions for causing the computer to confirm voltage stability of the first process corner voltage; instructions for causing the computer to perform an integrity check with the first process corner voltage; instructions for causing the computer to acquire a plurality of aging measurements on the plurality of processors by comparing an aging measurement on a first ring oscillator (RO) and on a second ring oscillator (RO) to a measurement threshold; and instructions for causing the computer to compute an average aging measurement from the plurality of aging measurements.

These and other aspects of the present disclosure will become more fully understood upon a review of the detailed description which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example first aging sequence for a plurality of voltage rails for a plurality of processors.

FIG. 2 illustrates an example validation phase for second aging sequence for a plurality of voltage rails for a plurality of processors.

FIG. 3 illustrates an example preparation phase for second aging sequence for a plurality of voltage rails for a plurality of processors.

FIG. 4 illustrates an example measurement phase for second aging sequence for a plurality of voltage rails for a plurality of processors.

FIG. 5 illustrates an example flow diagram for implementing determination of aging parameters for a plurality of voltage rails.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

In a multi-processor system with a plurality of processors, the load presented to the dc power management system may vary over time due to load aging phenomena. In one example, load aging phenomena are electrical characteristics which change over a long time scale (e.g., a time scale greater than days). For example, the load may draw higher or lower current at a given voltage level at some reference time compared to a nominal current at the given voltage level at beginning of life (i.e., t=0). For example, the change in current draw may require an adjustment in voltage level over time (i.e., t>0).

In one example, as the load varies due to load aging phenomena, the required voltage level may increase by a small margin. For example, up to 30 mV of voltage margin may be added to a system voltage margin budget to compensate for the load aging phenomena to further reduce dc power consumption. In one example, dc power management may incorporate an algorithm in firmware or in a bootloader to minimize the system voltage margin budget.

In one example, the load aging phenomena may be monitored using aging measurements. In one example, the aging measurements may be performed on two identical ring oscillators (ROs) with a first RO operated in a stressed mode with a maximum clock frequency Fmax and a second RO operated in a non-stressed mode with a minimum clock frequency Fmin. In one example, aging degradation may be defined as a difference between maximum clock frequency Fmax and minimum clock frequency Fmin. For example, the aging degradation scales at different operational modes which may be characterized with a scaling factor to derive a frequency degradation percentage. In one example, the maximum clock frequency is the maximum clock frequency of the first RO. In one example, the minimum clock frequency is the minimum clock frequency of the second RO.

In one example, the aging sequence includes calculating a maximum aging delta percentage and applying the maximum aging delta percentage to target parameters. For example, a first target parameter is a fused initial skew parameter defined as a difference between an initial minimum clock period T0.min and an initial maximum clock period T0.max. For example, a second target parameter is a difference between a fused later skew parameter and the initial skew parameter, divided by a later minimum clock period Tx.min. For example, the fused later skew parameter is defined as a difference between the later minimum clock period Tx, min and a later maximum clock period Tx,max. In one example, the fused initial skew parameter is used for compensation of an initial or new device bias level.

In one example, the aging sequence may consider a plurality of parameters to configure the plurality of processors. In one example, with a plurality of hardware entity enablements and a plurality of static settings across the plurality of processors, there may be numerous scenarios where the aging sequence operates sub-optimally which results in voltage margins appropriate for a worst-case scenario, not a realistic scenario.

In one example, a nominal voltage level may range from 500 mV to 1100 mV with a voltage margin up to 30 mV, depending on a specific load and failure statistics. As a result, the voltage margin may represent up to 6% of the nominal voltage level, which is a significant contributor to dc power consumption.

In one example, the aging sequence may be applied to all processors in the plurality of processors and with different firmware versions. In one example, a revised aging sequence may be employed to mitigate processor voltage rail aging failures with improved dc power efficiency and maintenance of accuracy and safety compliances and without degradation of boot time and related key performance indicators (KPIs).

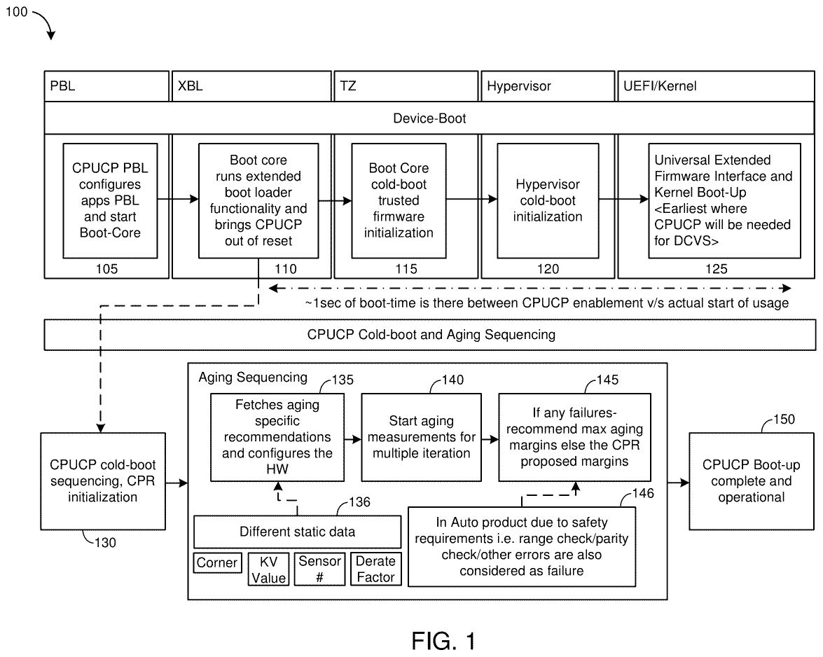

FIG. 1 illustrates an example first aging sequence 100 for a plurality of voltage rails for a plurality of processors. In block 105, a primary boot loader (PBL) configures application loading and commences a core bootup. In block 110, the core bootup executes an extended boot loader (XBL) functionality and initiates a control processor (CP) out of a reset state. In block 115, the core bootup commences a trusted firmware initialization. In block 120, a hypervisor commences a hypervisor initialization. In block 125, a universal extended firmware interface commences a kernel initialization. For example, a dynamic clock and voltage scaling (DCVS) operation is commenced no earlier than in block 125.

In block 130, subsequent to block 110, the control processor commences a cold bootup sequencing and initializes a core power reduction (CPR). For example, CPR optimizes voltage level settings on a plurality of voltage rails for the plurality of processors. In block 135, the control processor retrieves aging-specific recommendation data to configure the plurality of voltage rails. In one example, the aging-specific recommendation data are stored in a static data table 136. For example, the static data table 136 includes processor corner data, scaling data, sensor data and derate factor data.

In block 140, the control processor commences aging measurements for a number of iterations. In one example, the aging measurements utilize a comparison of ring oscillator frequencies under different process corner conditions. In one example, processor corner conditions are variations in operational parameters for the plurality of processors. For example, process corner conditions may include manufacturing variability, dc power consumption, temperature, clock speed, etc.

In block 145, if any aging failures are detected from the aging measurements, the control processor adjusts the voltage level settings away from the CPR-optimized voltage level settings. Otherwise, the CPR-optimized voltage level settings are maintained. In one example, the control processor further adjusts the voltage level settings to account for any automotive safety parameter errors 146, if applicable.

In block 150, the control processor finalizes the core bootup and transitions to an operational state.

In one example, the first aging sequence for a plurality of processors includes several challenges that require resolution. In one example, if one processor of the plurality of processors is not available for operational use due to certain constraints (e.g., licensing issues), the first aging sequence may recommend a worst-case aging margin. In one example, if a recommended process corner is not supported by the plurality of processors because of a plurality of processor constraints (e.g., multiple license variants), the first aging sequence may recommend a maximum aging margin.

In one example, a derating factor or a count of oscillations per volt may be statically defined and result in the first aging sequence yielding a non-optimal aging margin which is higher than necessary. In one example, a processor or sensor enablement failure (e.g., due to different finite state machine handshake protocols) may result in the first aging sequence recommending a worst-case aging margin. In one example, a voltage setting failure may result in the first aging sequence yielding inaccurate aging margins higher than necessary. In one example, a range check failure in at least one voltage measurement may results in the first aging sequence yielding a maximum aging margin.

In one example, a second aging sequence for a plurality of processors aims to mitigate the limitations of the first aging sequence. In one example, the second aging sequence includes a multistage recovery of an aging failure with a data validation phase, a preparation phase and a measurement phase.

In one example, for the data validation phase, the second aging sequence may define a preferred order of processors or sensors for the plurality of processors. In one example, if one processor or one recommended process corner is not available, the second aging sequence may select a second processor or a second recommended process corner instead. In one example, for the data validation phase, the second aging sequence may dynamically update a derating factor or a count of oscillations per volt for a more accurate aging margin calculation.

In one example, for the preparation phase, if enablement of one processor or one sensor or voltage settings or controller check fails, then the second aging sequence may initiate a recovery sequence or use another processor or sensor. In one example, in a non-recoverable failure scenario, the plurality of processors may be reset entirely to avoid system instability. In one example, for the preparation phase, a controller may initialize to an actual usage of DCVS in a defined time window (e.g., 100 ms duration) to allow multiple resets or complex operational sequences.

In one example, for the measurement phase, the second aging sequence may implement dynamic monitoring of a success ratio for measurement (e.g., measurement of RO frequency) and of provisioning of controller reset recovery. In one example, the second aging sequence allows for additional iterations over an available time window which results in a more accurate aging margin recommendation.

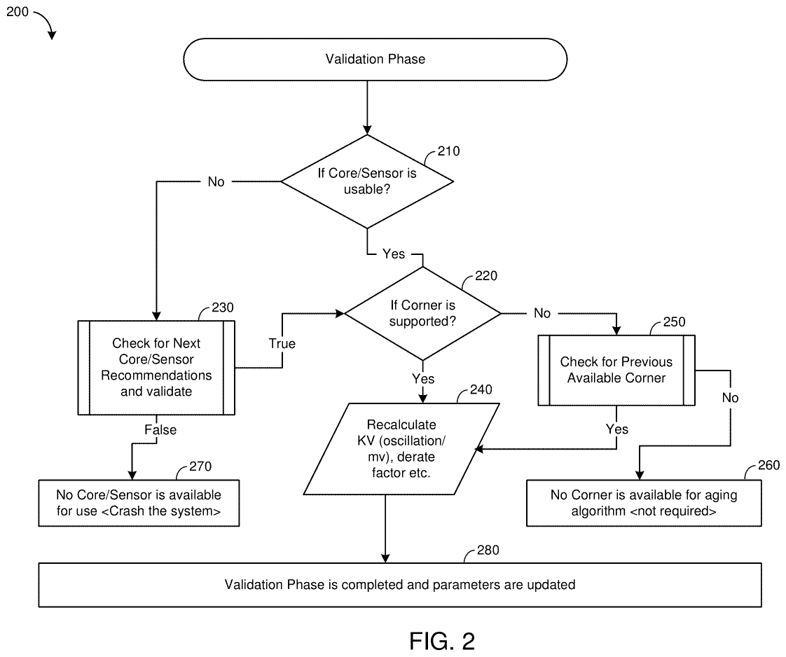

FIG. 2 illustrates an example validation phase 200 for second aging sequence for a plurality of voltage rails for a plurality of processors. In block 210, determine if a first processor of a plurality of processors or if a first sensor of a plurality of sensors is available for use. If available, proceed to block 220. In not available, proceed to block 230.

In block 220, determine if a first process corner is a viable operational setting. If viable, proceed to block 240. If not viable, proceed to block 250.

In block 240, recalculate a plurality of aging parameters. In one example, the plurality of aging parameters includes an oscillation scale factor Kv (e.g., oscillation per millivolt). In one example, the plurality of aging parameters includes a derating factor. For example, the plurality of aging parameters is dynamically based on component characteristics which are updated prior to an aging process. For example, the oscillation scale factor Kv may be dynamically updated. For example, the derating factor may be dynamically updated.

In block 280, update the plurality of aging parameters with the recalculated plurality of aging parameters for an operational phase. For example, update the oscillation scale factor Kv with a recalculated oscillation scale factor. For example, update the derating factor with a recalculated oscillation scale factor.

In block 230, determine if a second processor of the plurality of processors or if a second sensor of the plurality of sensors is available. If available, proceed to block 220. If not available, proceed to block 270.

In block 270, if no processors of the plurality of processors or if no sensors of the plurality of sensors are available for use, terminate the plurality of processors (e.g., execute a system shutdown).

In block 250, determine if a second processor corner is a viable operational setting. If viable, proceed to block 240. If not viable, proceed to block 260.

In block 260, if no processor corner is a viable operational setting, terminate the plurality of processors (e.g., execute a system shutdown).

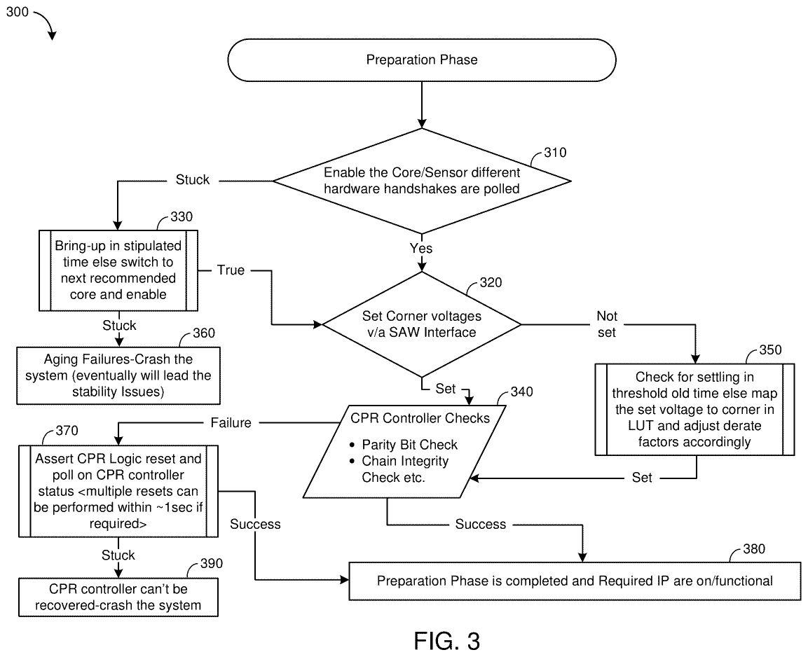

FIG. 3 illustrates an example preparation phase 300 for second aging sequence for a plurality of voltage rails for a plurality of processors. In block 310, enable and validate a first processor of a plurality of processors or a first sensor of a plurality of sensors. In one example, execute a plurality of interface handshakes with polling for the first processor or the first sensor. If validated, proceed to block 320. If not validated, proceed to block 330.

In block 320, set a first process corner voltage for one processor or one sensor over a voltage control interface and confirm voltage stability for the first process corner voltage. If voltage stability is confirmed, proceed to block 340. If voltage stability is not confirmed, proceed to block 350.

In block 330, enable and validate a second processor of the plurality of processors or a second sensor of the plurality of sensors. If validated, proceed to block 320. If not validated, proceed to block 360.

In block 340, perform an integrity check with the set process corner voltage. In one example, the integrity check includes a parity bit check. In one example, the integrity check includes a chain integrity check. In one example, the integrity check is performed by a controller. If the integrity check passes, proceed to block 380. If the integrity check fails, proceed to block 370.

In block 350, set a second process corner voltage for the one processor or the one sensor over the voltage control interface and confirm voltage stability for the second process corner voltage. In one example, the second process corner voltage includes a derating factor. In one example, the second process corner voltage is set after detecting voltage instability in the first processor corner voltage.

In block 360, if no processor of the plurality of processors or no sensor of the plurality of sensors is validated, terminate the plurality of processors (e.g., execute a system shutdown). In one example, lack of validation may be due to handshake conflict, interface bus packet loss, state machine faults, etc.

In block 370, assert a logic reset and poll controller status to verify if the integrity check is successful after logic reset. If successful, proceed to block 380. If unsuccessful, proceed to block 390.

In block 380, continue operation with the set process corner voltage.

In block 390, if the integrity check does not pass after asserting the logic reset, terminate the plurality of processors (e.g., execute a system shutdown).

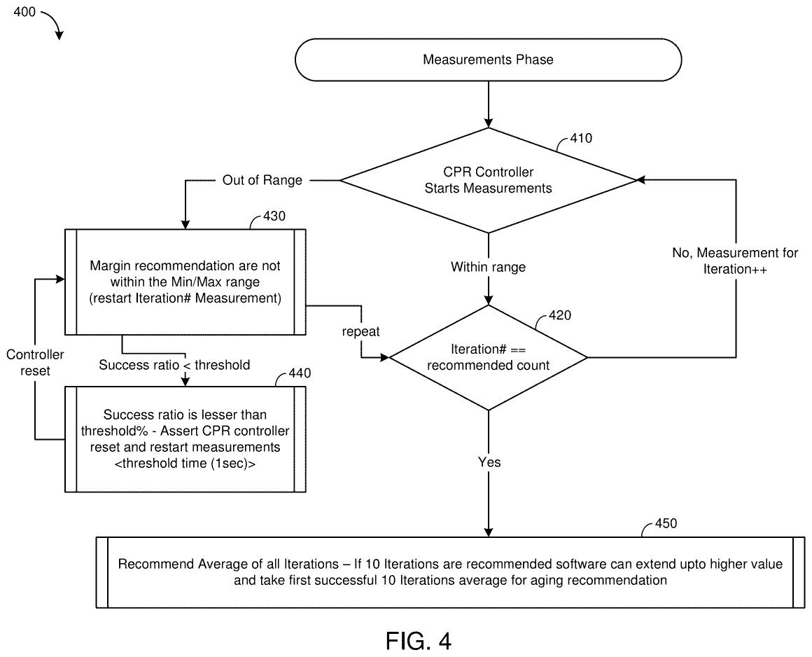

FIG. 4 illustrates an example measurement phase 400 for second aging sequence for a plurality of voltage rails for a plurality of processors. In block 410, commence a plurality of aging measurements on the plurality of processors by comparing a first aging measurement on a first ring oscillator (RO) and a second ring oscillator (RO) to a measurement threshold. In one example, the first aging measurement is performed with the first RO operated in a stressed mode with a maximum clock frequency Fmax and a second RO operated in a non-stressed mode with a minimum clock frequency Fmin.

In one example, the first aging measurement generates an aging degradation defined as a difference between maximum clock frequency Fmax and minimum clock frequency Fmin. In one example, the aging degradation scales at different operational modes with a scaling factor to derive a frequency degradation percentage. In one example, the measurement threshold is based on a current operational mode. If the first aging measurement is within the measurement threshold, proceed to block 420. If the first aging measurement is outside the measurement threshold, proceed to block 430.

In block 420, determine if an iteration count is greater than a maximum iteration count. If greater, proceed to block 450. If not greater, increment the iteration count to produce an updated iteration count and return to block 410 for a second aging measurement.

In block 430, restart the plurality of aging measurements and compare a success ratio against a success ratio threshold. In one example, the success ratio is defined as a ratio of aging measurements within the measurement threshold to all aging measurements. For example, a success ratio threshold of 50% maps into 10 aging measurements within the measurement threshold out of a total of 20 aging measurements. In one example, the maximum iteration count and success ratio threshold may vary with the application. If the success ratio is greater than the success ratio threshold, proceed to block 420. If the success ratio is less than or equal to the success ratio threshold, proceed to block 440.

In block 440, assert a controller reset and proceed to block 430 with additional aging measurements.

In block 450, compute an average aging measurement from the plurality of aging measurements. In one example, the average aging measurement is based on frequency measurements on the first RO and the second RO. In one example, the average aging measurement depends on the maximum iteration count.

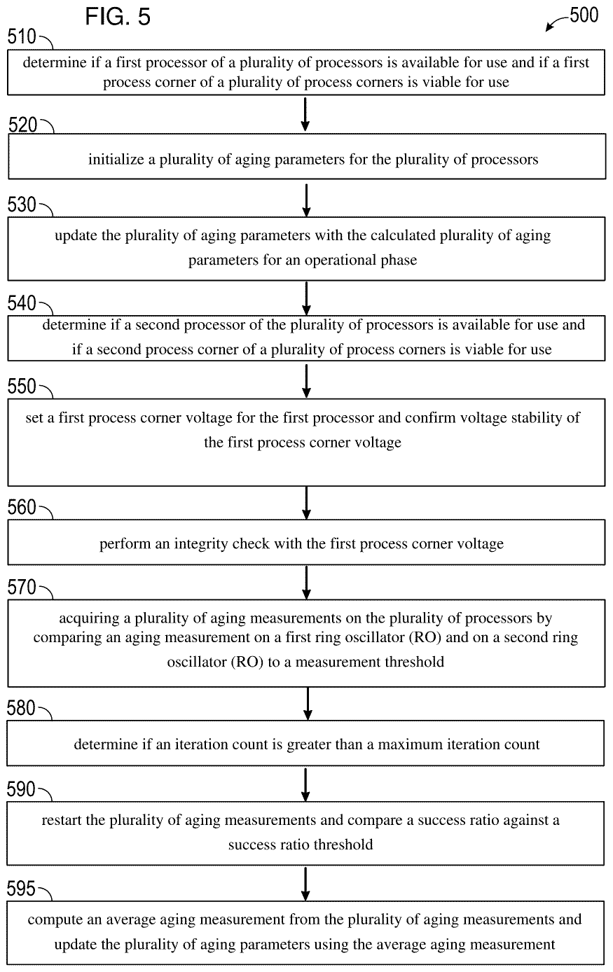

FIG. 5 illustrates an example flow diagram 500 for implementing determination of aging parameters for a plurality of voltage rails. In block 510, determine if a first processor of a plurality of processors is available for use and if a first process corner of a plurality of process corners is viable for use. In one example, a first processor of a plurality of processors is determined if it is available for use and a first process corner of a plurality of process corners is determined if it is viable for use. If available and viable for use, proceed to block 520. Otherwise, proceed to block 540. In one example, the plurality of processor corners includes variations in operational parameters for the plurality of processors. For example, process corner conditions may include manufacturing variability, dc power consumption, temperature, clock speed, etc. In one example, the step of block 510 may be performed by one or more of the following: a processing engine, a microcontroller, a microprocessor, a central processing unit (CPU), a controller, a processor, etc.

In block 520, initialize a plurality of aging parameters for the plurality of processors. In one example, a plurality of aging parameters for the plurality of processors is initialized. In one example, the plurality of aging parameters includes an oscillation scale factor Kv (e.g., oscillation per millivolt). In one example, the plurality of aging parameters includes a derating factor. For example, the plurality of aging parameters is dynamically based on component characteristics which are updated prior to an aging process. For example, the oscillation scale factor Kv may be dynamically updated. For example, the derating factor may be dynamically updated. In one example, the step of block 520 may be performed by one or more of the following: a processing engine, a microcontroller, a microprocessor, a central processing unit (CPU), a controller, a processor, etc.

In block 530, update the plurality of aging parameters with the calculated plurality of aging parameters for an operational phase. In one example, the plurality of aging parameters is updated with the calculated plurality of aging parameters for an operational phase. For example, update the oscillation scale factor Kv with a recalculated oscillation scale factor. For example, update the derating factor with a recalculated oscillation scale factor. In one example, the step of block 530 may be performed by one or more of the following: a processing engine, a microcontroller, a microprocessor, a central processing unit (CPU), a controller, a processor, etc.

In block 540, determine if a second processor of the plurality of processors is available for use and if a second process corner of a plurality of process corners is viable for use. In one example, a second processor of the plurality of processors is determined if it is available for use and a second process corner of a plurality of process corners is determined if it is viable for use. If available and viable for use, proceed to block 520. Else, terminate the plurality of processors (e.g., execute a system shutdown). In one example, the step of block 540 may be performed by one or more of the following: a processing engine, a microcontroller, a microprocessor, a central processing unit (CPU), a controller, a processor, etc.

In block 550, set a first process corner voltage for the first processor and confirm voltage stability of the first process corner voltage. In one example, a first process corner voltage for the first processor is set and voltage stability of the first process corner voltage is confirmed. If voltage stability is confirmed with the first process corner voltage, proceed to block 560 using the first process corner voltage. If voltage stability is not confirmed with the first process corner voltage, proceed to block 560 using the second process corner voltage. In one example, the step of block 550 may be performed by one or more of the following: a processing engine, a microcontroller, a microprocessor, a central processing unit (CPU), a controller, a processor, etc.

In block 560, perform an integrity check with the first process corner voltage. In one example, an integrity check is performed with the first process corner voltage. In one example, the integrity check includes a parity bit check. In one example, the integrity check includes a chain integrity check. In one example, the integrity check is performed by a controller. If the integrity check passes, proceed to block 570. If the integrity check fails, proceed to block 370. In one example, the step of block 560 may be performed by one or more of the following: a processing engine, a microcontroller, a microprocessor, a central processing unit (CPU), a controller, a processor, etc.

In block 570, acquiring a plurality of aging measurements on the plurality of processors by comparing an aging measurement on a first ring oscillator (RO) and on a second ring oscillator (RO) to a measurement threshold. In one example, a plurality of aging measurements on the plurality of processors is acquired by comparing an aging measurement on a first ring oscillator (RO) and on a second ring oscillator (RO) to a measurement threshold. In one example, the first aging measurement is performed with the first RO operated in a stressed mode with a maximum clock frequency Fmax and a second RO operated in a non-stressed mode with a minimum clock frequency Fmin. In one example, the first aging measurement generates an aging degradation defined as a difference between maximum clock frequency Fmax and minimum clock frequency Fmin. In one example, the aging degradation scales at different operational modes with a scaling factor to derive a frequency degradation percentage. In one example, the measurement threshold is based on a current operational mode. If the first aging measurement is within the measurement threshold, proceed to block 580. If the first aging measurement is outside the measurement threshold, proceed to block 590. In one example, the step of block 570 may be performed by one or more of the following: a processing engine, a microcontroller, a microprocessor, a central processing unit (CPU), a controller, a processor, etc.

In block 580, determine if an iteration count is greater than a maximum iteration count. In one example, an iteration count is determined if it is greater than a maximum iteration count. If greater, proceed to block 595. If not greater, increment the iteration count to produce an updated iteration count and return to block 570 for a second aging measurement. In one example, the step of block 580 may be performed by one or more of the following: a processing engine, a microcontroller, a microprocessor, a central processing unit (CPU), a controller, a processor, etc.

In block 590, restart the plurality of aging measurements and compare a success ratio against a success ratio threshold. In one example, the plurality of aging measurements is restarted and a success ratio is compared against a success ratio threshold. In one example, restart includes disposing the plurality of aging measurements and commencing with new measurement values. For example, the new measurement values may be obtain from the step in block 570. In one example, the success ratio is defined as a ratio of aging measurements within the measurement threshold to all aging measurements. For example, a success ratio threshold of 50% maps into 10 aging measurements within the measurement threshold out of a total of 20 aging measurements. In one example, the maximum iteration count and success ratio threshold may vary with the application. If the success ratio is greater than the success ratio threshold, return to block 580. If the success ratio is less than or equal to the success ratio threshold, proceed to assert a controller reset and proceed with additional aging measurements. In one example, the step of block 590 may be performed by one or more of the following: a processing engine, a microcontroller, a microprocessor, a central processing unit (CPU), a controller, a processor, etc.

In block 595, compute an average aging measurement from the plurality of aging measurements and update the plurality of aging parameters using the average aging measurement. In one example, an average aging measurement from the plurality of aging measurements is computed and the plurality of aging parameters is updated using the average aging measurement. In one example, the average aging measurement is based on frequency measurements on the first RO and the second RO. In one example, the average aging measurement depends on the maximum iteration count. In one example, the step of block 595 may be performed by one or more of the following: a processing engine, a microcontroller, a microprocessor, a central processing unit (CPU), a controller, a processor, etc.

In one aspect, the present disclosure includes an apparatus including: a non-transitory memory configured to store a plurality of aging parameters; a controller coupled to the non-transitory memory, the controller configured to perform a plurality of aging measurements on a plurality of processors using the plurality of aging parameters; and a databus coupling the non-transitory memory to the controller.

In one example, the controller is further configured to set a process corner voltage to maintain voltage stability for at least one of the plurality of processors. In one example, the controller is further configured to perform an integrity check with the process corner voltage.

In one example, the apparatus further includes a ring oscillator (RO) coupled to the controller, wherein the RO is configured to operate in a stressed mode with a clock frequency for the plurality of aging measurements, wherein the clock frequency is the maximum clock frequency of the RO. In one example, the apparatus further includes a ring oscillator (RO) coupled to the controller, wherein the RO is configured to operate in an unstressed mode with a clock frequency for the plurality of aging measurements, wherein the clock frequency is the minimum clock frequency of the RO.

In one example, the integrity check includes a parity bit check. In one example, the integrity check includes a chain integrity check. In one example, the controller is further configured to compute an average aging measurement of the plurality of aging measurements, and wherein the controller is further configured to update the plurality of aging parameters using the average aging measurement.

In one aspect, the present disclosure includes a method including: setting a first process corner voltage for the first processor; confirming voltage stability of the first process corner voltage; performing an integrity check with the first process corner voltage; acquiring a plurality of aging measurements on the plurality of processors by comparing an aging measurement on a first ring oscillator (RO) and on a second ring oscillator (RO) to a measurement threshold; computing an average aging measurement from the plurality of aging measurements; and updating a plurality of aging parameters using the average aging measurement.

In one example, the method further includes determining if the first processor of the plurality of processors is available for use and if a first process corner is viable for use. In one example, the method further includes initializing the plurality of aging parameters for the plurality of processors. In one example, the method further includes updating the plurality of aging parameters with the plurality of aging parameters for an operational phase. In one example, the method further includes restarting the plurality of aging measurements; and comparing a success ratio against a success ratio threshold. In one example, the method further includes determining if an iteration count is greater than a maximum iteration count. In one example, the method further includes determining if a second processor of the plurality of processors is available for use and if a second process corner of a plurality of process corners is viable for use.

In one aspect, the present disclosure includes a non-transitory computer-readable medium storing computer executable code, operable on a device including at least one processor and at least one memory coupled to the at least one processor, wherein the at least one processor is configured to implement determination of aging parameters for a plurality of voltage rails, the computer executable code including: instructions for causing a computer to set a first process corner voltage for the first processor; instructions for causing the computer to confirm voltage stability of the first process corner voltage; instructions for causing the computer to perform an integrity check with the first process corner voltage; instructions for causing the computer to acquire a plurality of aging measurements on the plurality of processors by comparing an aging measurement on a first ring oscillator (RO) and on a second ring oscillator (RO) to a measurement threshold; and instructions for causing the computer to compute an average aging measurement from the plurality of aging measurements.

In one example, the non-transitory computer-readable medium further includes: instructions for causing the computer to determine if the first processor of the plurality of processors is available for use and if a first process corner is viable for use; and instructions for causing the computer to initialize the plurality of aging parameters for the plurality of processors. In one example, the non-transitory computer-readable medium further includes: instructions for causing the computer to restart the plurality of aging measurements; and instructions for causing the computer to compare a success ratio against a success ratio threshold. In one example, the non-transitory computer-readable medium further includes: instructions for causing the computer to determine if an iteration count is greater than a maximum iteration count; and instructions for causing the computer to determine if a second processor of the plurality of processors is available for use and if a second process corner of a plurality of process corners is viable for use. In one example, the non-transitory computer-readable medium further includes: instructions for causing the computer to update a plurality of aging parameters using the average aging measurement.

In one aspect, one or more of the steps for providing multistage recovery (MSR) of processor voltage rail aging failures in FIG. 5 may be executed by one or more processors which may include hardware, software, firmware, etc. The one or more processors, for example, may be used to execute software or firmware needed to perform the steps in the flow diagram of FIG. 5. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another—even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
a non-transitory memory configured to store a plurality of aging parameters;
a controller coupled to the non-transitory memory, the controller configured to perform a plurality of aging measurements on a plurality of processors using the plurality of aging parameters; and
a databus coupling the non-transitory memory to the controller.

2. The apparatus of claim 1, wherein the controller is further configured to set a process corner voltage to maintain voltage stability for at least one of the plurality of processors.

3. The apparatus of claim 2, wherein the controller is further configured to perform an integrity check with the process corner voltage.

4. The apparatus of claim 3, further comprising a ring oscillator (RO) coupled to the controller, wherein the RO is configured to operate in a stressed mode with a clock frequency for the plurality of aging measurements, wherein the clock frequency is the maximum clock frequency of the RO.

5. The apparatus of claim 3, further comprising a ring oscillator (RO) coupled to the controller, wherein the RO is configured to operate in an unstressed mode with a clock frequency for the plurality of aging measurements, wherein the clock frequency is the minimum clock frequency of the RO.

6. The apparatus of claim 3, wherein the integrity check includes a parity bit check.

7. The apparatus of claim 3, wherein the integrity check includes a chain integrity check.

8. The apparatus of claim 1, wherein the controller is further configured to compute an average aging measurement of the plurality of aging measurements, and wherein the controller is further configured to update the plurality of aging parameters using the average aging measurement.

9. A method comprising:
setting a first process corner voltage for the first processor;
confirming voltage stability of the first process corner voltage;
performing an integrity check with the first process corner voltage;
acquiring a plurality of aging measurements on the plurality of processors by comparing an aging measurement on a first ring oscillator (RO) and on a second ring oscillator (RO) to a measurement threshold;
computing an average aging measurement from the plurality of aging measurements; and
updating a plurality of aging parameters using the average aging measurement.

10. The method of claim 9, further comprising determining if the first processor of the plurality of processors is available for use and if a first process corner is viable for use.

11. The method of claim 10, further comprising initializing the plurality of aging parameters for the plurality of processors.

12. The method of claim 11, further comprising updating the plurality of aging parameters with the plurality of aging parameters for an operational phase.

13. The method of claim 12, further comprising:
restarting the plurality of aging measurements; and
comparing a success ratio against a success ratio threshold.

14. The method of claim 13, further comprising determining if an iteration count is greater than a maximum iteration count.

15. The method of claim 14, further comprising determining if a second processor of the plurality of processors is available for use and if a second process corner of a plurality of process corners is viable for use.

16. A non-transitory computer-readable medium storing computer executable code, operable on a device comprising at least one processor and at least one memory coupled to the at least one processor, wherein the at least one processor is configured to implement determination of aging parameters for a plurality of voltage rails, the computer executable code comprising:
instructions for causing a computer to set a first process corner voltage for the first processor;
instructions for causing the computer to confirm voltage stability of the first process corner voltage;
instructions for causing the computer to perform an integrity check with the first process corner voltage;
instructions for causing the computer to acquire a plurality of aging measurements on the plurality of processors by comparing an aging measurement on a first ring oscillator (RO) and on a second ring oscillator (RO) to a measurement threshold; and
instructions for causing the computer to compute an average aging measurement from the plurality of aging measurements.

17. The non-transitory computer-readable medium of claim 16, further comprising:
instructions for causing the computer to determine if the first processor of the plurality of processors is available for use and if a first process corner is viable for use; and
instructions for causing the computer to initialize the plurality of aging parameters for the plurality of processors.

18. The non-transitory computer-readable medium of claim 17, further comprising:
instructions for causing the computer to restart the plurality of aging measurements; and
instructions for causing the computer to compare a success ratio against a success ratio threshold.

19. The non-transitory computer-readable medium of claim 18, further comprising:
instructions for causing the computer to determine if an iteration count is greater than a maximum iteration count; and
instructions for causing the computer to determine if a second processor of the plurality of processors is available for use and if a second process corner of a plurality of process corners is viable for use.

20. The non-transitory computer-readable medium of claim 19, further comprising:
instructions for causing the computer to update a plurality of aging parameters using the average aging measurement.
